(19) United States
(12) Patent Application Publication
(10) Pub. No.: US 2020/0189086 A1
(43) Pub. Date: Jun. 18, 2020

(54) ROTARY IMPACT TOOLS WITH NOISE REDUCTION MECHANISM

(71) Applicant: TTI (MACAO COMMERCIAL OFFSHORE) LIMITED, Macau (MO)

(72) Inventors: Rui LIANG, Dongguan (CN); Li Guo MA, Dongguan (CN); Jing Feng ZHOU, Dongguan (CN)

(21) Appl. No.: 16/328,143

(22) PCT Filed: Sep. 6, 2018
(86) PCT No.: PCT/CN2018/104356

§ 371 Date: Feb. 25, 2019

(51) Int. Cl. B25D 17/11

(52) U.S. Cl. CPC B25D 17/11; B25D 2250/365

(57) ABSTRACT

A power tool including a housing, a motor accommodated in the housing; and an output member connected to the motor via a transmission module. The transmission module is received in a substantially vacuum chamber in the housing. The vacuum chamber effectively reduces the propagation of noises generated by the transmission module to the outside of the power tool, thus improving the user experience.

### FIELD OF INVENTION

This invention relates to power tools, and in particular to vibration and noise reduction mechanisms for power transmission modules in power tools.

### BACKGROUND OF INVENTION

Power tools are used widely in industries and domestic environments to provide high efficiency operations. Typically power tools are equipped with electric motors which provide raw rotary power, which is then transformed to kinetic energy in other forms/other directions for driving a working piece. For example, for rotary impact tools including impact wrenches, impact drivers, and oil pulse tools, the rotational power from the electric motor is outputted as a linear striking power of an anvil and/or rotary movement of the anvil.

However, due to the impact mechanism present in rotary impact tools, these rotary impact tools generate strong noises during operation, which greatly affects the user experience. In rotary impact tools, the impacts are the major sources of noise, and the impacts mainly include mechanical shocks and hydraulic shocks. There are also vibrational noises generated as the tool is in operation.

### SUMMARY OF INVENTION

In the light of the foregoing background, it is an object of the present invention to provide an alternate rotary impact tool which eliminates or at least alleviates the above technical problems.

The above object is met by the combination of features of the main claim: the sub-claims disclose further advantageous embodiments of the invention.

One skilled in the art will derive from the following description other objects of the invention. Therefore, the foregoing statements of object are not exhaustive and serve merely to illustrate some of the many objects of the present invention.

Accordingly, the present invention in one aspect is a power tool including a housing, a motor accommodated in the housing; and an output member connected to the motor via a transmission module. The transmission module is received in a substantially vacuum chamber in the housing.

Preferably, the vacuum chamber is defined by a gear casing, the output member, and the motor.

More preferably, the output member or the motor is connected to the gear casing via washers and/or bushings.

According to a variation of preferred embodiments, the motor further contains a motor cover, and a motor pinion coupled to a motor shaft. The power tool further contains seals configured between the motor cover and the gear casing, and between the motor pinion and the gear casing.

In one specific implementation, the seals contain O-rings or Stepseal.

In another specific implementation, the gear casing contains an air valve adapted to suction air therefrom to implement the vacuum chamber.

According to another aspect of the invention, a method of manufacturing a power tool contains the steps of providing a gear casing in which a transmission module is received, providing an output member and a motor of the power tools, connecting the transmission module to the motor and the output member; and suctioning air from the gear casing to form a substantia vacuum chamber.

Preferably, the method further contains the step of configuring seals between the motor and the gear casing, as well as between the output member and the gear casing, prior to the suctioning step.

More preferably, the gear casing further contains an air valve. During the suctioning step the air in the gear casing is suctioned from the air valve.

There are many advantages to the present invention. The invention requires no substantial modifications to the structure of existing power tools, as the main idea is to create a vacuum environment to prevents noises from propagation. The only process required is to seal the interior chamber, pumping air out from the interior chamber, and adding soundproof materials, etc. The invention provides advantages including a simple structure, a low cost, convenient installation and the like. The invention can be applied to any power tool which contains power transmission modules that may generate noises.

### BRIEF DESCRIPTION OF FIGURES

The foregoing and further features of the present invention will be apparent from the following description of preferred embodiments which are provided by way of example only in connection with the accompanying figures, of which:

FIG. 1 is a cross-sectional view of a gear casing in a rotary impact tool according to one embodiment of the invention.

FIG. 2a shows the cross-sectional view of a dynamic seal that can be used in the rotary impact tool in FIG. 1.

FIG. 2b shows the cross-sectional view of a static seal that can be used in the rotary impact tool in FIG. 1.

FIG. 3 is a flowchart showing the method steps of making a vacuum chamber in the power tool according to another embodiment of the invention.

In the drawings, like numerals indicate like parts throughout the several embodiments described herein.

### DETAILED DESCRIPTION OF THE PREFERRED EMBODIMENTS

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Terms such as “horizontal”, “vertical”, “upwards”, “downwards”, “above”, “below” and similar terms as used herein are for the purpose of describing the invention in its normal in-use orientation and are not intended to limit the invention to any particular orientation.

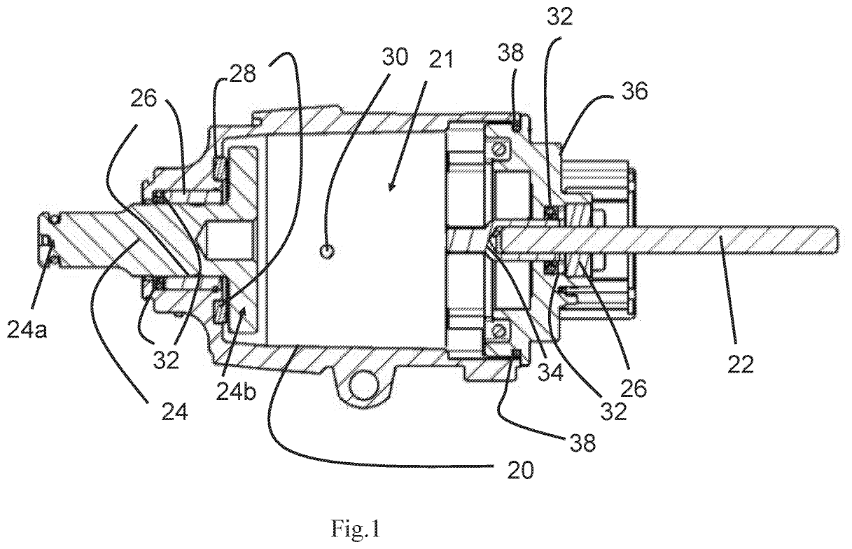

Referring now to FIG. 1, the first embodiment of the present invention is a rotary impact tool where FIG. 1 shows a gear casing 20 connected to a motor and an anvil 24. The gear casing 20 is located in a housing (not shown) of the rotary impact tool but in other embodiments the gear casing may be a part of the housing (which means that the gear casing is exposed to the outside of the rotary impact tool). The gear casing 20 connects to the housing, the motor, and other components of the rotary impact tool such as circuit boards by screws. The gear casing 20 receives a power transmission module (not shown) of the rotary impact tool, and for simplicity of illustration, the transmission module is omitted from FIG. 1. It should be noted that the transmission module is not the key part to the invention and in fact the transmission module can be any known or future mechanisms for rotary impact tools. For example the transmission module may include a gear reduction module and a movement translation module adapted to transform a rotary movement to a reciprocating movement. No matter what type of the transmission module is placed in the gear casing, the invention will be applicable, since the essential technical solution for achieving intended results of the invention reside in the gear casing and how it is connected to other components. In particular, the interior of the gear casing 20 is substantially in vacuum, thus forming a vacuum chamber 21 in which the transmission module is accommodated.

The gear casing 20 is connected to the motor and the anvil 24 at two ends of the gear casing 20 since the transmission module in the gear casing 20 is intended to transform the raw motor output to a desired form of movement of the anvil 24. For example, the anvil 24 as an output member is adapted to rotate at a speed lower than that of the motor shaft 22 but with a much larger torque than that of the motor shaft 22. Alternatively or additionally, the anvil 24 is adapted to perform complex movements relative to the gear casing 20 such as forward rotation, reverse rotation, reciprocating axial movement, small-amplitude reciprocating swing, and instant start and stop. An output end of the gear casing 20, the anvil 24 is coupled to the gear casing 20 through washers 28 and bushings 26. The anvil 24 is adapted to rotate through the bushings 26 and the frictions between the anvil 24 and the gear casing 20 are reduced due to the washers 28. A dynamic seal 32 is present between the anvil 24 and the gear casing 20 as this type of seal could ensure its tightness under complex movements such as those mentioned between the anvil 24 and the gear casing 20, and the dynamic seal 32 is also necessary to be able to form an oil film (not shown) of sufficient thickness and to prevent excessive loss of lubricating oil (not shown).

On an input end of the gear casing 20, there is coupled a motor casing 36 and a static seal 38 between the gear casing 20 and the motor casing 36. The static seal 38 is simpler than the dynamic seal 32 since the relative movement between the motor casing 36 and the gear casing 20 is small. A motor pinion 34 which is connected to an end of the motor shaft 22 protrudes from the motor casing 36 into the gear casing 20. The motor pinion 34 is movable relative to the gear casing 20, for example the motor pinion 34 is capable of rotating continuously in either forward or reverse direction. Bushings 26 are present between the motor shaft 22 and the motor casing 36 to form a groove (not shown) for a dynamic seal 32 between the motor casing 36 and the motor pinion 34 to be received. The dynamic seal 32 between the motor casing 36 and the motor pinion 34 have similar design requirements as those of the dynamic seal 32 between the anvil 24 and the gear casing 20.

On the gear casing 20 there is also an air valve 30 which connects the vacuum chamber 21 to the atmosphere. The air valve 30 is preferably a check valve which is supposed to extract air from the vacuum chamber 21 when the air valve 30 is opened and which can seal the vacuum chamber 21 for a long time when it is closed, and which would resist vibration.

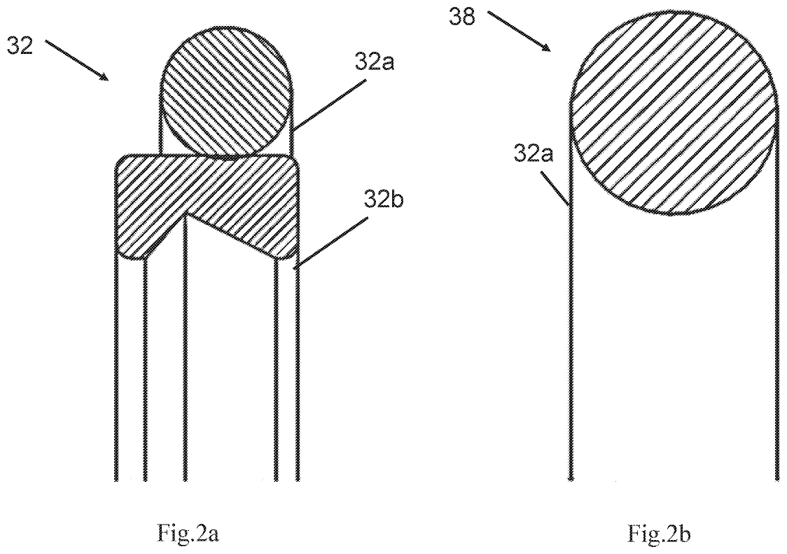

FIGS. 2a and 2b show respectively examples of the dynamic seal 32 and the static seal 38. The dynamic seal 32 consists of an O-ring 32a and a Stepseal 32b interfering with each other as known to skilled persons in the art. The static seal 38 contains only an O-ring 32a.

Now turning to the operation of the rotary impact tool described above, during the operation noises may be generated from various sources including includes teeth-to-teeth meshing within the gear box, the impact between the anvil 24 and an impact block (not shown) in the vacuum chamber which is driven by the motor pinion 34. The vacuum chamber 21 could isolate impact noises along most of the directions, and noise is only transmitted from two components which are the motor pinion 34 and anvil 24 to the air, which greatly reduces the number of sound propagation paths and reduces the impact noise of the tool.

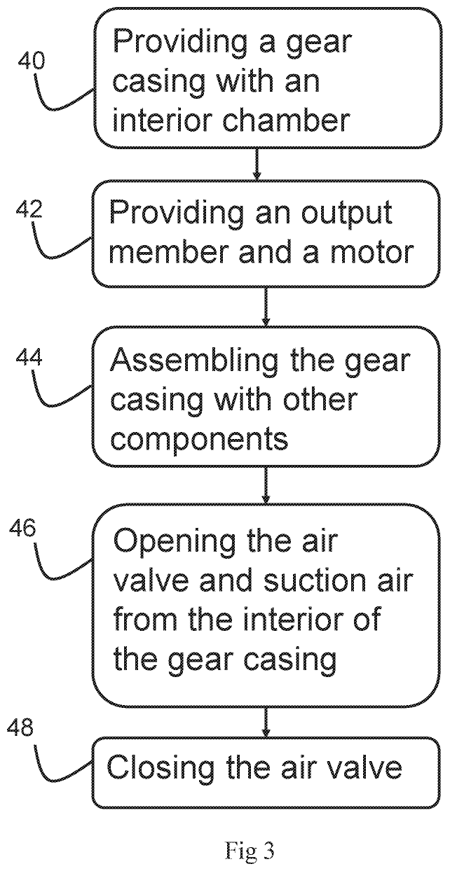

Turning now to FIG. 3, the flowchart shows how the rotary impact tool with a vacuum chamber similar to that described and illustrated in FIGS. 1-2b can be manufactured. It should be noted that only the procedures of forming the vacuum chamber is described, and the assembling of other part of the rotary impact tool which is not relevant to the invention is not described herein. In Step 40 a gear casing is provided in which an interior chamber is defined. Next, in Step 42 an output member of the tool as well as a motor is provided. In Step 44, the gear casing is connected by screws to other parts of the impact tool such as the motor, the output member, the housing of the tool, and electronic components. After the gear casing is assembled, an air valve on the gear casing is opened in Step 46 for a pump to suction air out of the gear casing to reduce the air density in the chamber of the gear casing. Finally, in Step 48 after the chamber becomes substantially vacuum, the air valve is closed, and the vacuum chamber is thus formed.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

It is to be understood that, if any prior art publication is referred to herein, such reference does not constitute an admission that the publication forms a part of the common general knowledge in the art, in Australia or any other country.

The detailed descriptions made to the preferred embodiments are by reference to a rotary impact tool. However, one skilled in the art should realize that the invention may also be applied to any other type of power tools, either electric or non-electric, as long as noises from an internal chamber of a component needs to be eliminated or reduced.

In addition, to better reduce the impact noise, in some variations of the invention the anvil can be split into two or more blocks with intermediate damper(s) connecting these blocks. Additionally or alternatively, the central bore of the anvil can be made larger so as to reduce the area of the cross-section of the anvil which otherwise facilitates transmission of the noise, provided that the strength of the anvil is guaranteed. The surfaces of the bushings) and washer(s) can be wrapped with a wear-resistant, sound-proof polymer material that prevents vibrational noise on the anvil from being transmitted to the atmosphere directly through the gear casing.

1-9. (canceled)

10. A power tool comprising:
a power tool housing;
a motor having a motor housing supported within the power tool housing;
a transmission housing coupled to the motor housing, the transmission housing supported within the power tool housing;
a vacuum chamber defined at least partially by the motor housing and the transmission housing;
a transmission positioned within the vacuum chamber, the transmission coupled to the motor for the motor to drive the transmission; and
an output member coupled to the transmission for the transmission to drive the output member.

11. The power tool of claim 10, further comprising a valve configured to allow air to exit the vacuum chamber through the valve.

12. The power tool of claim 11, wherein the valve is coupled to the transmission housing.

13. The power tool of claim 12, wherein the valve is a check valve configured to inhibit air from entering the vacuum chamber through the check valve.

14. The power tool of claim 10, further comprising a first seal positioned between the motor housing and a shaft of the motor, wherein the first seal is configured to inhibit air from exiting the vacuum chamber between the shaft of the motor and the motor housing.

15. The power tool of claim 14, wherein the vacuum chamber is also defined by the output member, wherein a second seal is positioned between the transmission housing and the output member, and wherein the second seal is configured to inhibit air from exiting the vacuum chamber between the output member and the transmission housing.

16. The power tool of claim 15, wherein the output member is an anvil that interacts with an impact block.

17. A power tool comprising:
a power tool housing;
a motor supported within the power tool housing;
a transmission coupled to the motor for the motor to drive the transmission;
a chamber positioned within the power tool housing, the chamber sized to receive at least a portion of the transmission, the chamber including a first pressure, the first pressure configured to be less than a second pressure that is exterior of the power tool housing; and
an output member coupled to the transmission for the transmission to drive the output member.

18. The power tool of claim 17, further comprising a transmission housing supported within the power tool housing, wherein the chamber is at least partially defined by the transmission housing.

19. The power tool of claim 18, wherein the motor includes a motor housing supported within the power tool housing, and wherein the chamber is at least partially defined by the motor housing.

20. The power tool of claim 17, further comprising a valve configured to allow air to exit the chamber through the valve.

21. The power tool of claim 20, wherein the valve is coupled to the transmission housing.

22. The power tool of claim 21, wherein the valve is a check valve configured to inhibit air from entering the chamber through the check valve.

23. The power tool of claim 18, wherein the chamber is also at least partially defined by a motor housing of the motor, wherein a first seal is positioned between the motor housing and a shaft of the motor, and wherein the first seal is configured to inhibit air from exiting the chamber between the shaft of the motor and the motor housing.

24. The power tool of claim 23, wherein the chamber is also at least partially defined by the output member, wherein a second seal is positioned between the transmission housing and the output member, and wherein the second seal is configured to inhibit air from exiting the chamber between the output member and the transmission housing.

25. The power tool of claim 24, wherein a third seal is positioned between the transmission housing and the motor housing, and wherein the third seal is configured to inhibit air from exiting the chamber between the transmission housing and the motor housing.

26. A method of manufacturing a power tool, the method comprising:
positioning a transmission within a chamber of the power tool;
coupling a motor to the transmission for the motor to drive the transmission;
coupling an output member to the transmission for the transmission to drive the output member; and
removing air from the chamber to form a first pressure within the chamber less than a second pressure that is exterior of the power tool.

27. The method of claim 26, wherein removing the air from the chamber includes removing the air from the chamber through a check valve.

28. The method of claim 26, further comprising inhibiting air from exiting the chamber by a first seal positioned between a motor housing that partially defines the chamber and a shaft of the motor.

29. The method of claim 28, further comprising inhibiting air from exiting the chamber by a second seal positioned between a transmission housing that partially defines the chamber and the output member.
